(19) United States
(12) Patent Application Publication
(10) Pub. No.: US 2007/0230226 A1
(43) Pub. Date: Oct. 4, 2007

(54) Multilevel intelligent universal auto-transformer

(76) Inventors: Jih-Sheng Lai, Blacksburg, VA (US); Arindam Maitra, Knoxville, TN (US); Frank Goodman, Palo Alto, CA (US)

Correspondence Address: KILPATRICK STOCKTON LLP, 1001 WEST FOURTH STREET, WINSTON-SALEM, NC, 27101, US

(21) Appl. No.: 11/705,077

(22) Filed: Feb. 8, 2007

Related U.S. Application Data
(63) Continuation-in-part of application No. 11/438,785, filed on May 22, 2006.
Application No. 11/438,785 is a continuation of application No. 10/723,621, filed on Nov. 25, 2003, now Pat. No. 7,050,311.
Application No. 11/438,785 is a continuation-in-part of application No. 11/246,800, filed on Oct. 7, 2005.
Application No. 11/246,800 is a division of application No. 10/723,620, filed on Nov. 25, 2003, now Pat. No. 6,954,366.

(51) Int. Cl. H02M 1/12; H02J 1/10

(52) U.S. Cl. 363/65

(57) ABSTRACT

A power conversion device includes a first switched converter circuit coupled to a device input and a second switched converter circuit coupled to the first switched converter circuit and a device output. The first switched converter circuit and the second switched converter circuit may be configurable for multi-level step-up and/or step-down conversion.

### CROSS-REFERENCE TO RELATED APPLICATIONS

This application is a continuation-in-part of pending U.S. patent application Ser. No. 11/438,785, filed May 22, 2006; which is a continuation of U.S. patent application Ser. No. 10/723,621, filed Nov. 25, 2003, now U.S. Pat. No. 7,050,311; and is a continuation-in-part of pending U.S. patent application Ser. No. 11/246,800, filed Oct. 7, 2005; which is a divisional of U.S. patent application Ser. No. 10/723,620, filed Nov. 25, 2003, now U.S. Pat. No. 6,954,366. Each of the foregoing applications and patents are incorporated by reference herein in their entireties.

### TECHNICAL FIELD

The present invention relates generally to power conversion technology and in particular to a universal autotransformer for enhancing the functionality of power conversion.

### BACKGROUND

Transformers have numerous applications including voltage or current conversion, impedance matching and electrical isolation. As a consequence, transformers are widely used throughout the world, forming the backbone of electric power conversion systems, and make up a large portion of power delivery systems. The positive attributes of conventional transformers have been well documented for years and include low cost, high reliability, and high efficiency. Were it not for these highly reliable devices, activities such as recharging batteries in a portable device or consumers receiving power from a distant electric generator would be prohibitively expensive, resulting in electricity being a much less practical form of energy.

Autotransformers are a subset of transformers in which primary and secondary coils have some or all of their windings in common. FIG. 1 illustrates a conventional autotransformer 100 that may be used to convert an input V₁ 110, having a first ac voltage and current level and a first frequency, to an output V₂ 112, having a second ac voltage and current level and a second frequency equal to the first frequency. Conventional autotransformers, such as the conventional autotransformer 100, typically utilize a copper and iron-based core to perform such a power transformation. In the conventional auto-transformer 100, the second ac voltage and current level may be adjusted by selecting a number of windings or taps in the core that are coupled to the output V₂ 112.

Conventional auto-transformers, however, have some drawbacks. The first voltage of the input V₁ 110 is typically higher than the second voltage of the output V₂ 112. Power typically flows only from the primary side to the secondary side. In addition, the voltage of the output V₂ 112 drops under load; there is a sensitivity to harmonics generated in a load; environmental impacts occur if mineral oil in the core leaks; there is little or no flexibility in adjusting the power conversion (including voltages/currents, and/or the first or second frequencies); and there is no energy-storage capacity. One consequence of not having energy storage capacity is that the output V₂ 112 can be easily interrupted because of a disturbance at the input V₁ 110.

There is a need, therefore, for improved auto-transformers.

### SUMMARY

A multilevel intelligent universal transformer includes power electronics on a primary side and on a secondary side to enhance the functionality of power conversion. The multilevel intelligent universal transformer may be an auto-transformer.

In some embodiments, a power conversion device includes a first switched converter circuit coupled to a device input and a second switched converter circuit coupled to the first switched converter circuit and a device output. The first switched converter circuit and the second switched converter circuit may be configurable for multi-level step-up and/or step-down conversion.

The first switched converter circuit and the second switched converter circuit may be configured to utilize duty-cycle modulation to implement the multi-level step-up and/or step-down conversion.

An energy storage device (e.g., ultra-capacitor) may be coupled between the first switched converter circuit and the second switched converter circuit to mitigate voltage disturbances.

A first filter may be coupled to an input of the first switched converter circuit and/or a second filter may be coupled to an output of the second switched converter circuit. The first filter and the second filter may be configured to provide substantially sinusoidal signals.

The first switched converter circuit may include a first plurality of configurable semiconductor switches and second switched converter circuit may include a second plurality of configurable semiconductor switches.

In some embodiments, the first switched converter circuit is configured to adjust a first number of conversion levels of signals at the device input, and/or the second switched converter circuit is configured to adjust a second number of conversion levels of signals at the device output.

In some embodiments, the first switched converter circuit is a half-bridge or a full-bridge converter. In some embodiments, the second switched converter circuit is a half-bridge or a full-bridge converter.

In some embodiments, the device is configurable for bidirectional power flow. In some embodiments, a frequency of signals at the device output is configurable.

In some embodiments, the first switched converter circuit is configured to receive signals at the device input having 3-phases separated by approximately 120°. In some embodiments, the second switched converter circuit is configured to output signals at the device output having 3-phases separated by approximately 120°.

A significant advantage of the present invention is the combining of the functionalities of one or more custom power devices into a single, tightly integrated, electrical device, rather than the costly conventional solution of utilizing separate custom power devices.

### BRIEF DESCRIPTION OF THE DRAWINGS

FIG. 1 is a circuit diagram illustrating a conventional auto-transformer;

FIG. 2 is a circuit diagram illustrating an embodiment of a universal transformer;

FIG. 3 is a circuit diagram illustrating an embodiment of a universal transformer;

FIG. 4 is a circuit diagram illustrating an embodiment of a universal transformer;

FIG. 5 is a circuit diagram illustrating an embodiment of a universal transformer;

FIG. 6 is a circuit diagram illustrating an embodiment of a universal transformer;

FIG. 7 is a circuit diagram illustrating an embodiment of a universal transformer;

FIG. 8 is a circuit diagram illustrating an embodiment of a control system;

FIG. 9 is a flow diagram illustrating an embodiment of a process of operation of a universal transformer; and

FIG. 10 is a block diagram illustrating an embodiment of a system.

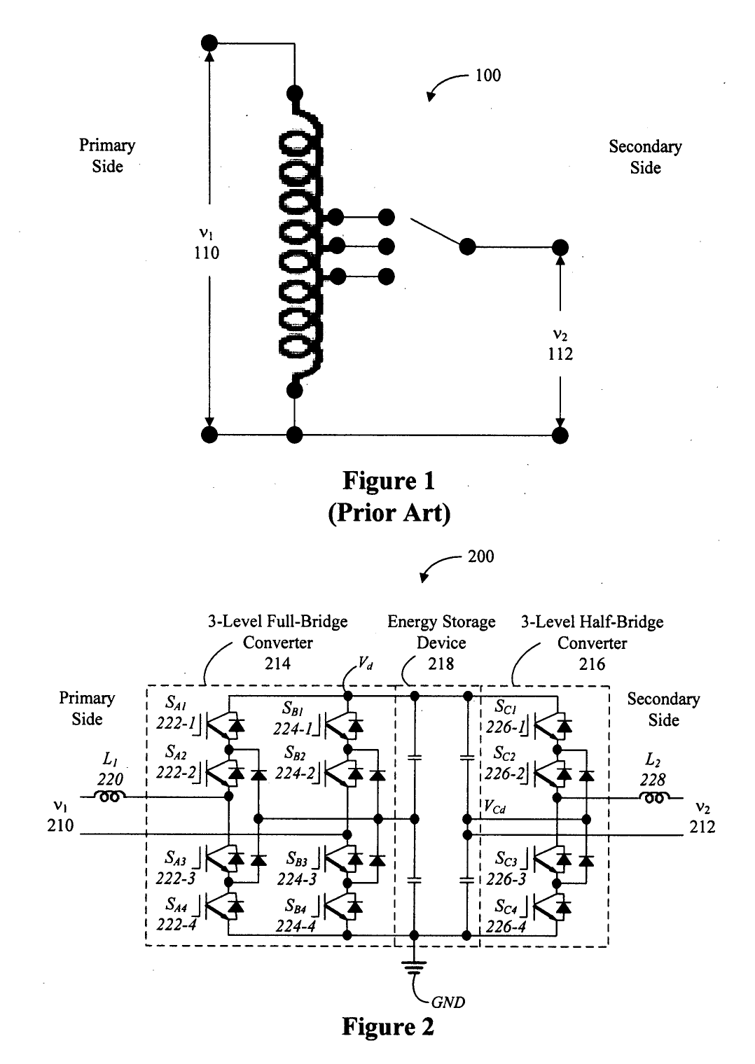

Like reference numerals refer to corresponding parts throughout the drawings.

### DETAILED DESCRIPTION

Reference will now be made in detail to embodiments of a multilevel intelligent universal auto-transformer (henceforth referred to as a universal auto-transformer), examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and circuits have not been described in detail so as not to unnecessarily obscure aspects of the embodiments.

The universal auto-transformer utilizes modern power electronics to replace the core in a conventional auto-transformer and thereby enhances the power conversion functionality. In some embodiments, the universal auto-transformer includes a plurality of power semiconductor switches in at least first and second switched converter circuits corresponding to the primary side and the secondary side, respectively, of a conventional auto-transformer.

The universal auto-transformer may include an energy storage device, such as one or more capacitors, between the first and the second switched converter circuits. The energy storage device may serve as the energy buffer in between the source and load to avoid direct impact from either the load to the source or the source to the load. The energy storage device may allow the universal auto-transformer to at least partially compensate for outages, where input signals to the universal auto-transformer are temporarily reduced (such as voltage sag) or disrupted.

The power electronic switches in the first and the second switched converter circuits may allow the universal auto-transformer to be configured in a variety of ways. The universal auto-transformer may be configured for one of a range of step-up or step-down voltage and/or current conversions. A voltage and/or current of the output signals may be regulated. Harmonics generated by nonlinearities in a load, as seen from the input, may be reduced or eliminated. A frequency of the output signals may be adjusted and/or selected (e.g., DC, 50 Hz, 60 Hz, 400 Hz, etc.). The input and/or the output signals may be approximately uni-phase or poly-phase, such as tri-phase signals where signals are separated by approximately 120°. In addition, the universal auto-transformer may be configured for bidirectional power flow. For example, power may flow from the primary side to the secondary side or from the secondary side to the primary side.

These features allow the universal auto-transformer to integrate the functionalities of one or more custom power devices. Such a “hybrid” universal auto-transformer thereby overcomes at least some of the deficiencies of existing auto-transformers, such as the conventional auto-transformer 100, in a cost effective manner.

FIG. 2 is a circuit diagram illustrating an embodiment of a universal transformer 200. The universal transformer 200 illustrates a multilevel converter single-phase to single-phase step-down auto-transformer. The universal transformer 200 includes a 3-level full-bridge converter 214, a 3-level half-bridge converter 216, and an energy storage device 218. The universal transformer 200 has a supply voltage V_{d}, a common voltage V_{Cd}, and a ground GND. The 3-level full-bridge converter 214 on the primary side includes two groups of four switches S_{A} 222 and S_{B} 224, as well as anti-parallel diode protection. The 3-level half-bridge converter 216 on the secondary side includes four switches S_{C} 226 and anti-parallel diode protection.

The energy storage device 218 includes a plurality of capacitors, connected in series, that are in parallel with an output from the 3-level full-bridge converter 214 and an input to the 3-level half-bridge converter 216. In some embodiments, the energy storage device 218 may include a battery. The energy storage device 218 may be any DC voltage source capable of maintaining voltage for a sufficient period of time to compensate for a disturbance or interruption, such as an outage, and may include capacitor banks, ultra-capacitors, flywheels, batteries, or any other suitable storage media (or any combination thereof). If the universal transformer 200 is used in an application or system that requires outage compensation or short-term interruption protection, the energy storage device 218 may allow the universal transformer 200 to ride-through these disturbances. When a voltage of an input V₁ 210 drops for a short period of time, the energy storage device 218 may compensate for the deficit and maintain constant voltage amplitude for an output V₂ 212. The total period of compensation as a function of the amount of energy storage may be adapted as desired. In some embodiments, an additional device, such as a battery, in the energy storage device 218 may be switched into the universal transformer 200 upon detection of a voltage sag and/or to provide outage compensation.

The universal transformer 200 converts the input V₁ 210 to the output V₂ 212. Duty cycle modulation of signals (for example, using pulse width modulation) controlling the switches S_{A} 222, S_{B} 224, and/or S_{C} 226 allows the step-down voltage (between the input V₁ 210 and the output V₂ 212) to be adjusted and/or configured. In an exemplary embodiment, a common duty cycle is used for control signals to the switches S_{A} 222, S_{B} 224, and S_{C} 226, and a voltage amplitude of the input V₁ 210 is approximately twice the voltage amplitude of the output V₂ 212. In this example, power is flowing from the primary side to the secondary or load side. The 3-level full-bridge converter 214 functions as a converter, and the 3-level half-bridge converter 216 functions as an inverter. In other embodiments, power may flow from the secondary side to the primary side. In this case, the 3-level full-bridge converter 214 functions as a inverter, and the 3-level half-bridge converter 216 functions as a converter

The inductors L₁ 220 and L₂ 228 in conjunction with an input and an output capacitance, respectively, form low-pass filters to provide filtering of high frequencies signals and/or smoothing of noise. In this way, the input V₁ 210 is approximately sinusoidal having the first frequency and/or the output V₂ 212 is approximately sinusoidal having the second frequency. An approximately sinusoidal signal has substantially reduced ripple. In some embodiments, the first frequency may be different that the second frequency (e.g., DC, 50 Hz, 60 Hz, or 400 Hz) depending on the duty cycle modulation of the switches S_{A} 222, S_{B} 224, and/or S_{C} 226. Note that other combinations of passive and/or active devices can be coupled to the primary side and/or the secondary side of the universal transformer 200 to provide filtering using well-known filter design techniques.

The switches S_{A} 222, S_{B} 224, and/or S_{C} 226 may be semiconductor switches that may be rapidly switched (approximately at 30,000 to 40,000 Hz). The switches S_{A} 222, S_{B} 224, and/or S_{C} 226 may include Gate-Turn-Off (GTO) Thyristors, Integrated Gate Bipolar Transistors (IGBTs), MOS Turn-off Thyristors (MTOs), Integrated-Gate Commutated Thyristors (IGCTs), Silicon Controlled Rectifiers (SCRs), or any other semiconductor devices that have a turn-off capability.

In addition to performing power conversion and/or adjustment or selection of the second frequency, the universal transformer 200 will also isolate the voltage of the input V₁ 210 and the current from the output V₂ 212. Thus, transients, such as those generated by a power factor correction capacitor switching event, will not propagate to the secondary or load side of the universal transformer 200. In addition, harmonics, such as those generated in a non-linear load or by reactive power in the load, will not propagate to the primary side. This may be accomplished by actively switching the switches S_{A} 222 and S_{B} 224 in the full-bridge converter 214 such that an input current becomes sinusoidal and in phase with the voltage of the input V₁ 210.

In some embodiments, the universal transformer 200 may include fewer components or additional components. For example, a number of switches and/or their switching frequency may be different from that illustrated in the universal transformer 200. Functions of two or more components may be combined. An order or relative position of two or more components may be interchanged.

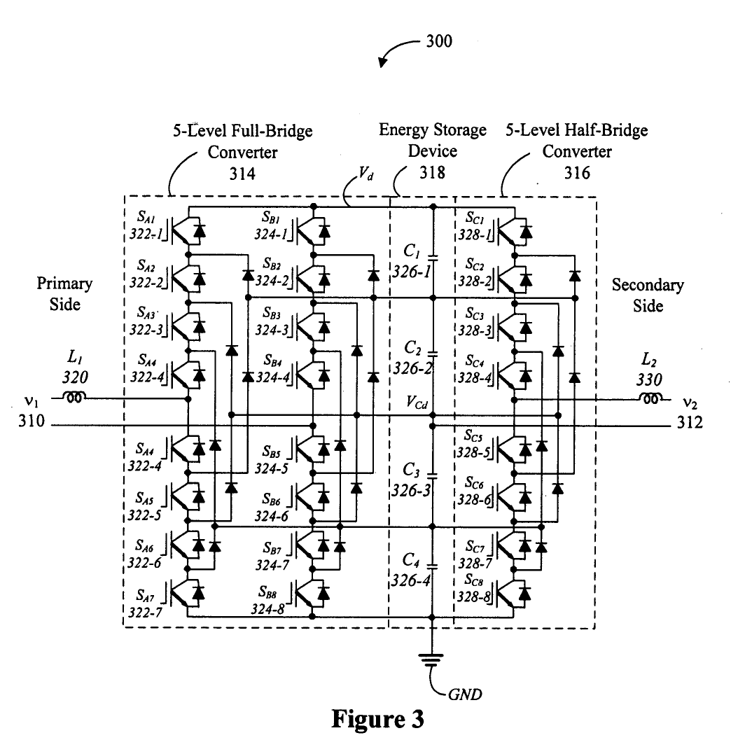

FIG. 3 is a circuit diagram illustrating an embodiment of a universal transformer 300. The universal transformer 300 converts the input V₁ 310 to the output V₂ 312 using a 5-level full-bridge converter 314, a 5-level half-bridge converter 316, and an energy storage device 318. The universal transformer 300 has a supply voltage V_{d}, a common voltage V_{Cd}, and a ground GND. The 5-level full-bridge converter 314 on the primary side includes two groups of eight switches S_{A} 322 and S_{B} 324, as well as anti-parallel diode protection. The 5-level half-bridge converter 316 on the secondary side includes eight switches S_{C} 328 and anti-parallel diode protection. The energy storage device 318 includes a plurality of capacitors 326, connected in series, that are in parallel with an output from the 5-level full-bridge converter 314 and an input to the 5-level half-bridge converter 316. In some embodiments, the energy storage device 318 may include an additional device, such as a battery, as described above for the universal auto-transformer 200 (FIG. 2). The universal auto-transformer 300 may also include inductors L₁ 320 and L₂ 330 or other active or passive components to provide filtering of high frequencies signals and/or smoothing of noise.

While the function of the switches S_{A} 322, S_{B} 324, and S_{C} 328 and the universal auto-transformer 300 (and the switches in the embodiments described below) as a whole is similar to that of the switches S_{A} 222, S_{B} 224, and S_{C} 226 (FIG. 2) and the universal auto-transformer 200 (FIG. 2), increasing the number of levels (and switches) has advantages for higher voltage applications. Each of the switches S_{A} 322, S_{B} 324, and S_{C} 328 only needs to block a quarter of the DC bus voltage. As a consequence, the universal transformer 300 may be used with higher high-voltages for the input V₁ 310 and/or the output V₂ 312 without using higher voltage devices for the switches S_{A} 322, S_{B} 324, and/or S_{C} 328.

In some embodiments, the universal transformer 300 may include fewer components or additional components. For example, a number of switches and/or their switching frequency may be different from that illustrated in the universal transformer 300. Functions of two or more components may be combined. An order or relative position of two or more components may be interchanged.

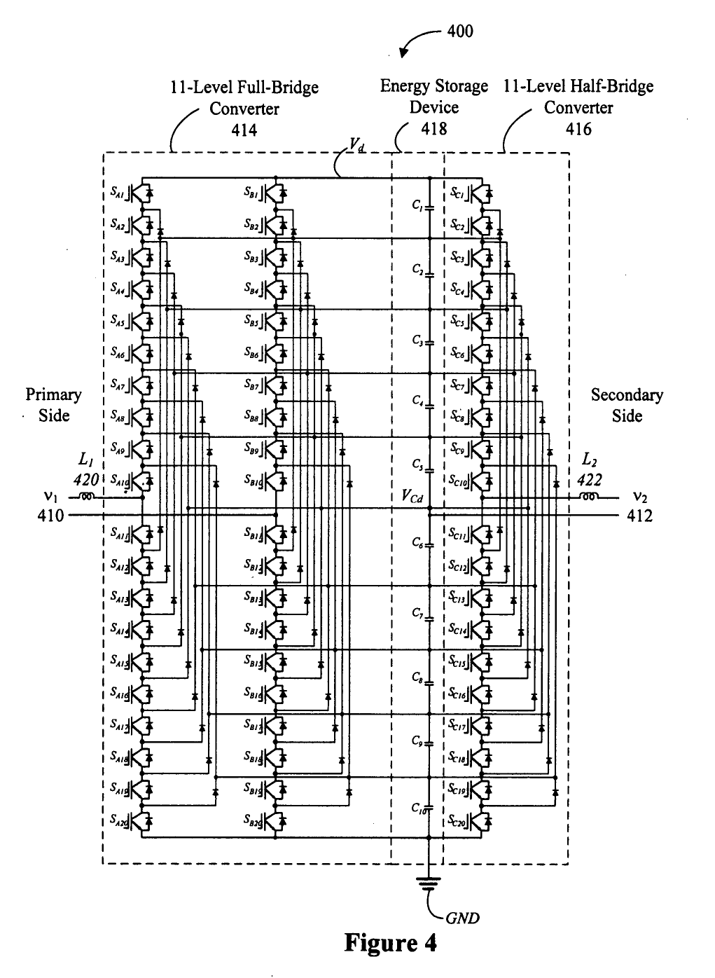

For higher voltages, the number of converter levels and switches may be further increased, as illustrated in FIG. 4, which shows is a circuit diagram of an embodiment of a universal transformer 400. The universal transformer 400 converts the input V₁ 410 to the output V₂ 412 using an 11-level full-bridge converter 414, an 11-level half-bridge converter 416, and an energy storage device 418. The universal transformer 400 has a supply voltage V_{d}, a common voltage V_{Cd}, and a ground GND. The 11-level full-bridge converter 414 on the primary side includes two groups of 20 switches S_{A} and S_{B}, as well as anti-parallel diode protection. The 11-level half-bridge converter 416 on the secondary side includes 20 switches S_{C} and anti-parallel diode protection. The energy storage device 418 includes a plurality of capacitors C, connected in series, that are in parallel with an output from the 11-level full-bridge converter 414 and an input to the 11-level half-bridge converter 416. In some embodiments, the energy storage device 418 may include an additional device, such as a battery, as described above for the universal auto-transformer 200 (FIG. 2). The universal auto-transformer 400 may also include inductors L₁ 420 and L₂ 422 or other active or passive components to provide filtering of high frequencies signals and/or smoothing of noise. In an exemplary embodiment, the input V₁ 410 is 345 kV and the output V₂ 412 is 220 kV.

In some embodiments, the universal transformer 400 may include fewer components or additional components. For example, a number of switches and/or their switching frequency may be different from that illustrated in the universal transformer 400. Functions of two or more components may be combined. An order or relative position of two or more components may be interchanged.

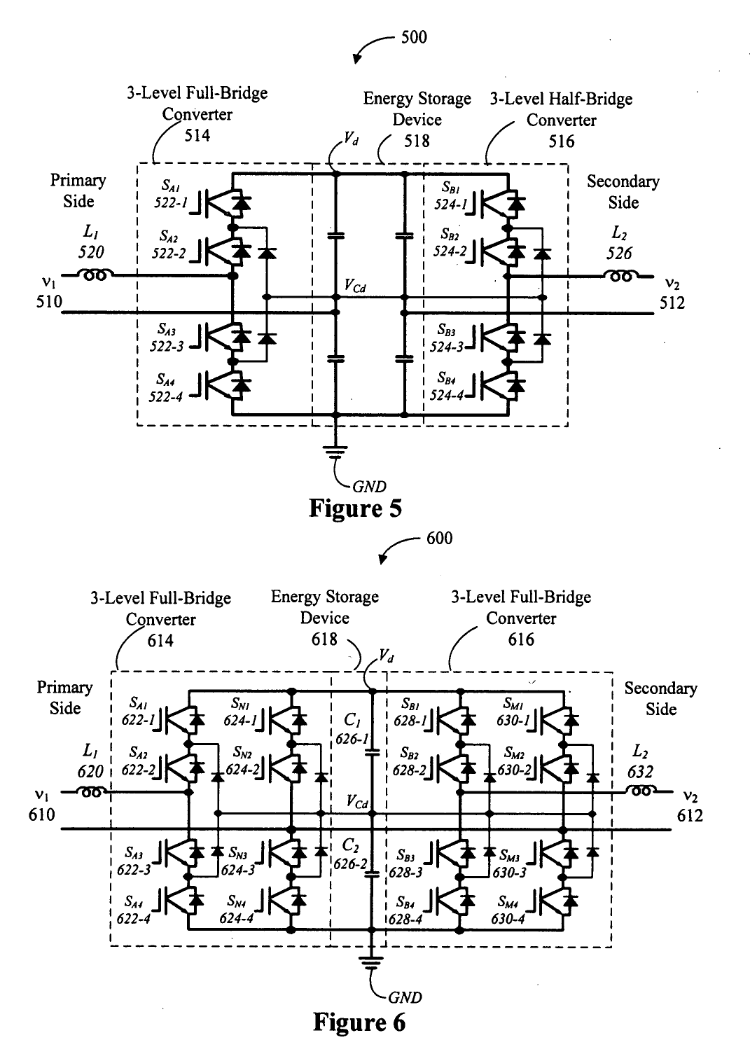

If the primary and the secondary sides of a universal auto-transformer have the same or similar voltages levels, the device can be simplified, for example, by using half-bridge converters on both sides of the universal auto-transformer. This is illustrated in FIG. 5, which shows an embodiment of a universal transformer 500. The universal transformer 500 converts the input V₁ 510 to the output V₂ 512 using a 3-level half-bridge converter 514, a 3-level half-bridge converter 516, and an energy storage device 518. The universal transformer 500 has a supply voltage V_{d}, a common voltage V_{Cd}, and a ground GND. The 3-level half-bridge converter 514 on the primary side includes four switches S_{A} 522 and anti-parallel diode protection. The reduced number of switches in this embodiment 500 reduces the overall cost. The 3-level half-bridge converter 516 on the secondary side includes four switches S_{B} 524 and anti-parallel diode protection. The energy storage device 518 includes a plurality of capacitors, connected in series, that are in parallel with an output from the 3-level half-bridge converter 514 and an input to the 3-level half-bridge converter 516. In some embodiments, the energy storage device 518 may include an additional device, such as a battery, as described above for the universal auto-transformer 200 (FIG. 2). The universal auto-transformer 500 may also include inductors L₁ 520 and L₂ 526 or other active or passive components to provide filtering of high frequencies signals and/or smoothing of noise.

In some embodiments, the universal transformer 500 may include fewer components or additional components. For example, a number of switches and/or their switching frequency may be different from that illustrated in the universal transformer 500. Functions of two or more components may be combined. An order or relative position of two or more components may be interchanged.

As illustrated in the preceding discussion, the number of configurable switches on the primary and/or the secondary side of the universal auto-transformer may be selected and/or configured. In some embodiments, a first number of switches in the converter circuit on the primary side is based on a voltage of signals at the device input and a voltage limit of the switches in the converter circuit on the primary side. In some embodiments, a second number of switches in the converter circuit on the secondary side is based on a voltage of signals at the device output and a voltage limit of the switches in the converter circuit on the secondary side. For example, the first number of switches may be increased if the voltage of signals at the device input is increased and/or the voltage limit of the switches in the converter circuit on the primary side is decreased.

As illustrated in embodiments 200 (FIG. 2), 300 (FIG. 3), 400 (FIG. 4), and 500, the first number of switches in the converter on the primary side and/or the second number of switches in the converter on the secondary side may vary based on the design and/or application considerations. In some embodiments, the first number of switches equals 2(N₁−1), 3(N₁−1), 4(N₁−1), or 6(N₁−1), where N₁ is a number of conversion levels of the signals at the device input. In some embodiments, the second number of switches equals 2(N_{O}−1), 3(N_{O}−1), 4(N_{O}−1), and 6(N_{O}−1), where N_{O} is a number of conversion levels of the signals at the device output. For example, for 3 conversion levels, the number of switches in a half-bridge converter circuit may be 4, and the number of switches in a full-bridge converter circuit may be 8.

In some embodiments, full-bridge converters may be used on both the primary and the secondary side of the universal auto-transformer. While the second number of switches is doubled relative to embodiments such as the universal auto-transformer 200 (FIG. 2), the maximum voltage of the output is also doubled. This is illustrated in FIG. 6, which shows an embodiment of a universal transformer 600. The universal transformer 600 converts the input V₁ 610 to the output V₂ 612 using a 3-level full-bridge converter 614, a 3-level full-bridge converter 616, and an energy storage device 618. The universal transformer 600 has a supply voltage V_{d}, a common voltage V_{Cd}, and a ground GND. The 3-level full-bridge converter 614 on the primary side includes two groups of four switches S_{A} 622 and S_{B} 624, as well as anti-parallel diode protection. The 3-level full-bridge converter 616 on the secondary side includes two groups of four switches S_{C} 628 and SD 630, as well as anti-parallel diode protection. The energy storage device 618 includes a plurality of capacitors C 626, connected in series, that are in parallel with an output from the 3-level full-bridge converter 614 and an input to the 3-level full-bridge converter 616. In some embodiments, the energy storage device 618 may include an additional device, such as a battery, as described above for the universal auto-transformer 200 (FIG. 2). The universal auto-transformer 600 may also include inductors L₁ 620 and L₂ 632 or other active or passive components to provide filtering of high frequencies signals and/or smoothing of noise.

In some embodiments, the universal transformer 600 may include fewer components or additional components. For example, a number of switches and/or their switching frequency may be different from that illustrated in the universal transformer 600. Functions of two or more components may be combined. An order or relative position of two or more components may be interchanged.

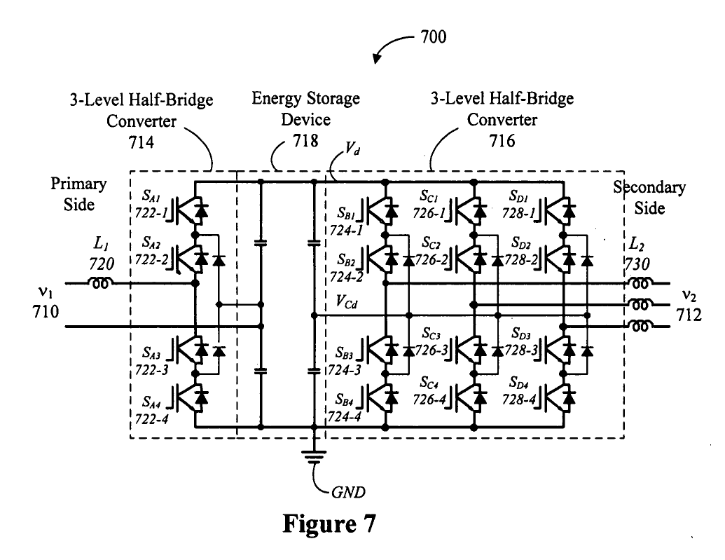

The universal auto-transformer may also be configured and/or used to convert single-phase input signals into poly-phased output signals. This is illustrated in FIG. 7, which shows a circuit diagram illustrating an embodiment of a universal transformer 700. The universal transformer 700 converts the input V₁ 710 to a three-phase the output V₂ 712 (having approximately 120° between the signals) using a 3-level half-bridge converter 714, a 3-level half-bridge converter 716, and an energy storage device 718. The universal transformer 700 has a supply voltage V_{d}, a common voltage V_{Cd}, and a ground GND. The 3-level half-bridge converter 714 on the primary side includes four switches S_{A} 722 and anti-parallel diode protection. The 3-level half-bridge converter 716 on the secondary side includes three groups of four switches S_{B} 724, S_{C} 726, and S_{D} 728, as well as anti-parallel diode protection. The energy storage device 718 includes a plurality of capacitors, connected in series, that are in parallel with an output from the 3-level half-bridge converter 714 and an input to the 3-level half-bridge converter 716. In some embodiments, the energy storage device 718 may include an additional device, such as a battery, as described above for the universal auto-transformer 200 (FIG. 2). The universal auto-transformer 700 may also include inductors L₁ 720 and L₂ 730 or other active or passive components to provide filtering of high frequencies signals and/or smoothing of noise.

In some embodiments, the universal transformer 700 may include fewer components or additional components. For example, a number of switches and/or their switching frequency may be different from that illustrated in the universal transformer 700, such as would be needed if one or more full-bridge converters are used instead of half-bridge converters. Alternatively, poly-phase input signals may be converted into single-phase output signals. Functions of two or more components may be combined. An order or relative position of two or more components may be interchanged.

Referring to FIG. 2, the universal auto-transformer 200 is used as an illustrative example of the operation of other embodiments of the universal auto-transformer. The basic operation is to switch first pair of switches S_{A1} 222-1 and S_{A2} 222-2 and second pair of switches S_{B3} 224-3 and S_{B4} 224-4, and to switch third pair of switches S_{A3} 222-3 and S_{A4} 222-4 and fourth pair of switches S_{B1} 224-1 and S_{B2} 224-2, in an alternating fashion such that an output of the 3-level half-bridge converter 216 is an alternating chopped DC voltage. The switches S_{C} 226 are similarly paired and switched. The filter associated with L₂ 228 smoothes the resulting chopped DC voltage into a clean, sinusoidal waveform.

The switches S_{A} 222, S_{B} 224, and/or S_{C} 226 may be controlled by an external control means using either analog or digital control signals in a manner commonly known to one of ordinary skill in the art. For example, the states of switches S_{A} 222, S_{B} 224, and/or S_{C} 226 may be controlled using pulse-width modulation (PWM) techniques. In PWM, the width of pulses in a pulse train are modified in direct proportion to a small control voltage. By using a sinusoid of a desired frequency as the control voltage, it is possible to produce a waveform whose average voltage varies sinusoidally in a manner suitable for driving the switches S_{A} 222, S_{B} 224, and/or S_{C} 226.

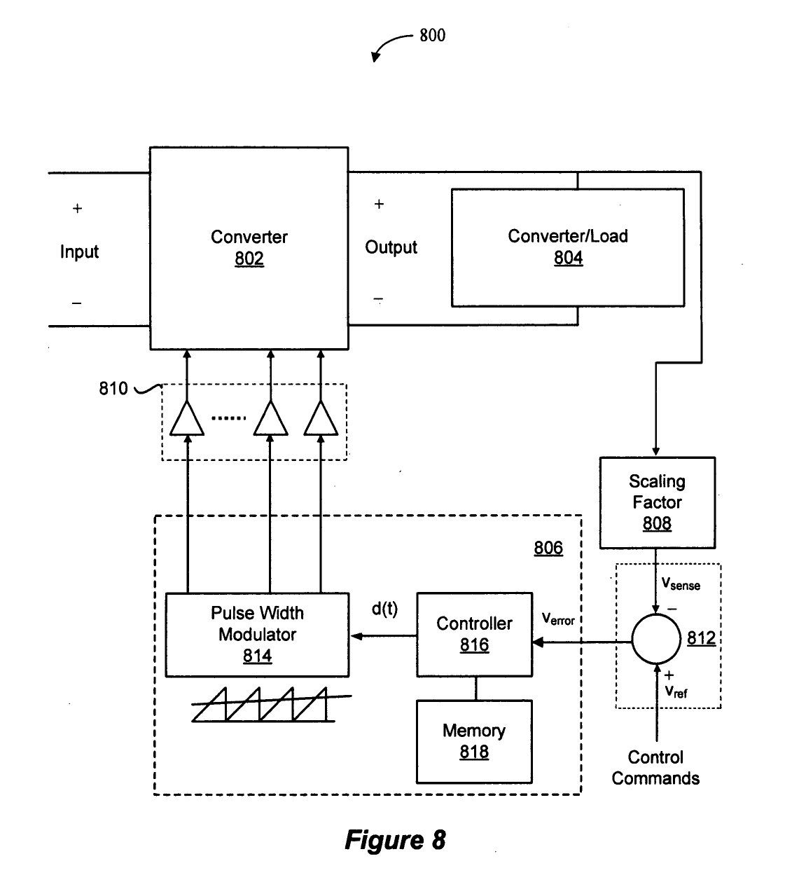

Signals used for driving the switches S_{A} 222, S_{B} 224, and/or S_{C} 226 may be provided by a control system. This is illustrated in FIG. 8, which is a circuit diagram showing an embodiment of a feedback control system 800. The feedback control system 800 includes a processor 806 (e.g., microcomputer, digital signal processor), a scaling factor circuit 808, a set of gate drivers 810, and a command interface 812. The processor further includes a pulse width modulator 814, a controller 816, and memory 818 (e.g., DRAM, CD-ROM). The scaling factor circuit 808 and the gate drivers 810 isolate control signals from the power.

In operation, the processor 806 compares a command voltage, V_{ref}, and a scaled feedback output signal, Vₛₑₙₛₑ, to determine an error signal, Vₑᵣᵣₒᵣ. The feedback signal, Vₛₑₙₛₑ, is taken from the output of the converter 802. The error signal, Vₑᵣᵣₒᵣ, is received by the controller 816, which generally applies a proportional (P), proportional-integral (PI), or proportional-integral-differentiator (PID) gain to the error signal. The output of the controller is a smooth duty cycle signal, d(t). Note that in a typical application either a load (e.g., adjustable speed drive) or another converter 804 is coupled to the output of the converter 802.

The duty cycle of each switch in the converter 802 is computed by the processor 806 based on one or more computer programs or gate pattern logic stored in the memory 818. The resulting duty cycle signal, d(t), is then sent to the pulse width modulator 814 (PWM), which generally includes a set of voltage comparators. In some embodiments, one comparator is used for each pair of switches. For example, the switch pair S_{A1} 222-1 and S_{A2} 222-2 (FIG. 2) in the actively switched full-bridge converter 214 (FIG. 2) may be controlled by a first comparator, and the switch pair S_{A3} 222-3 and S_{A4} 222-4 (FIG. 2) may be controlled by a second comparator. The PWM signals are then fed into the gate drivers 810 to turn the switches in the converter 802 on or off. The number of switches in the converter 802 depends on how many voltage levels and phases are to be controlled.

The control voltages d(t) (and therefore the output pulse width) can be varied to achieve different frequencies and voltage levels in any desired manner. For example, the processor 806 can implement various acceleration and deceleration ramps, current limits, and voltage-versus-frequency curves by changing variables (e.g., via the command interface 812) in control programs or gate pattern logic in processor 806.

If the duty cycle d(t) is greater than the voltage level of a reference waveform (e.g., a triangular waveform) at any given time t, then the PWM circuit 814 will turn on the upper switches (e.g., switches S_{A1} 222-1 and S_{A2} 222-2) of the full-bridge converter 214 (FIG. 2) and turn off the lower switches (e.g., switches S_{A3} 222-3 and S_{A4} 222-4) of the full-bridge converter 214 (FIG. 2). For a three-phase PWM inverter embodiment (e.g., the embodiment 700 shown in FIG. 7), three single-phase control circuits may be used with control voltages comprising sinusoidal waveforms shifted by approximately 120° between phases using techniques well-known in the art.

In some embodiments, the control system 800 includes a detection circuit configured to detect when the input power source has a missing phase or is running under a single-phase condition and to generate control signals to be used by the command interface 812 to shut off the switches in one or more phase-legs of the universal auto-transformer.

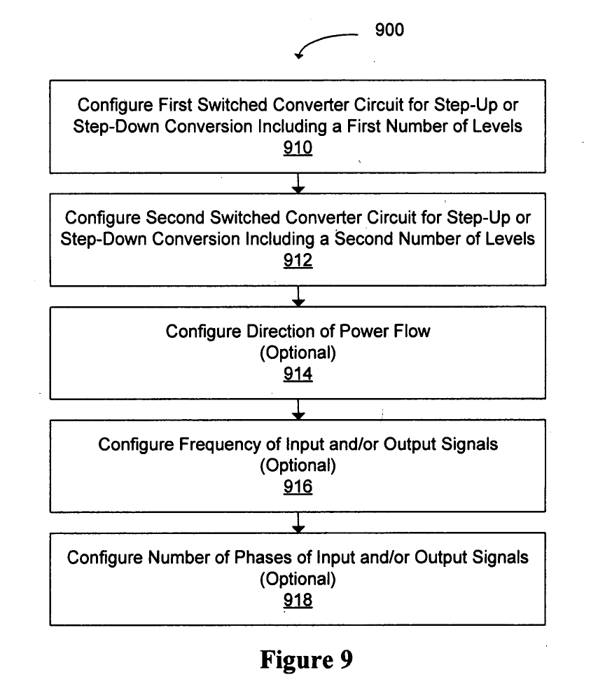

As noted in the previous discussion, in some embodiments the universal auto- transformer may be dynamically configured. This is illustrated in FIG. 9, which is a flow diagram of an embodiment of a process of operation 900 of a universal transformer. A first switched converter circuit is configured for step-up or step-down conversion including a first number of conversion levels 910. A second switched converter circuit is configured for step-up or step-down conversion including a second number of conversion levels 912. A direction of power flow is optionally configured 914. Frequencies of input and/or output signals are optionally configured 916. A number of phases of the input and/or output signals is optionally configured 918. The process of operation 900 may include fewer operations or additional operations. An order or position of two or more operations may be changed. Two or more operations may be combined into a single operation.

Devices and circuits described herein can be implemented using computer aided design tools available in the art, and embodied by computer readable files containing software descriptions of such circuits, at behavioral, register transfer, logic component, transistor, and layout geometry level descriptions stored on storage media or communicated by carrier waves. Data formats in which such descriptions can be implemented include, but are not limited to, formats supporting behavioral languages like C; formats supporting register transfer level RTL languages like Verilog and VHDL; and formats supporting geometry description languages like GDSII, GDSIII, GDSIV, CIF, MEBES, and other suitable formats and languages. Data transfers of such files on machine readable media including carrier waves can be done electronically over the diverse media on the Internet or through email, for example. Physical files can be implemented on machine readable media such as 4 mm magnetic tape, 8 mm magnetic tape, 3½ inch floppy media, CDs, DVDs, and so on.

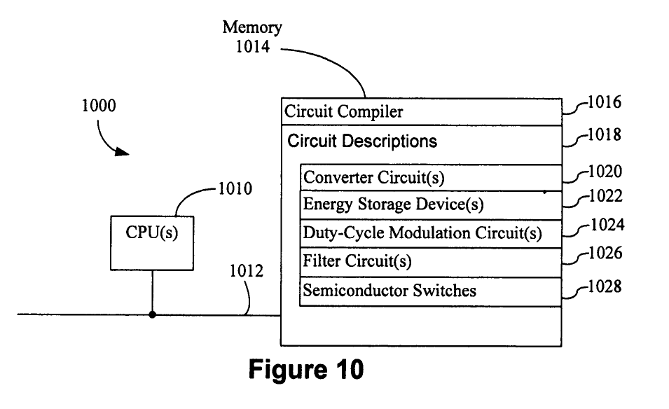

FIG. 10 is a block diagram an embodiment of a system 1000 for storing computer readable files containing software descriptions of the circuits. The system 1000 may include at least one data processor or central processing unit (CPU) 1010, a memory 1014, and one or more signal lines 1012 for coupling these components to one another. The one or more signal lines 1012 may constitute one or more communications busses.

The memory 1014 may include high-speed random access memory and/or non-volatile memory, such as one or more magnetic disk storage devices. The memory 1014 may store a circuit compiler 1016 and circuit descriptions 1018. The circuit descriptions 1018 may include circuit descriptions for one or more converter circuits 1020, one or more energy storage devices 1022, one or more duty-cycle modulation circuits 1024, one or more filter circuits 1026, and semiconductor switches 1028.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications to thereby enable others skilled in the art to best utilize the invention and various embodiments with various modifications as are suited to the particular use contemplated.

What is claimed is:

1. A power conversion device, comprising:
a first switched converter circuit coupled to a device input; and
a second switched converter circuit coupled to the first switched converter circuit and a device output,
wherein the first switched converter circuit and the second switched converter circuit are configurable for multi-level step-up or step-down conversion.

2. The device of claim 1, wherein the first switched converter circuit is a full-bridge converter.

3. The device of claim 1, wherein the first switched converter circuit is a half-bridge converter.

4. The device of claim 1, wherein the second switched converter circuit is a full-bridge converter.

5. The device of claim 1, wherein the second switched converter circuit is a half-bridge converter.

6. The device of claim 1, wherein the first switched converter circuit and the second switched converter circuit comprise a symmetric half-bridge converter pair.

7. The device of claim 1, wherein the first switched converter circuit and the second switched converter circuit comprise a symmetric full-bridge converter pair.

8. The device of claim 1, wherein the first switched converter circuit and the second switched converter circuit are configured to utilize duty-cycle modulation to implement the multi-level step-up or step-down conversion.

9. The device of claim 1, further comprising an energy storage device coupled between the first switched converter circuit and the second switched converter circuit to mitigate voltage disturbances.

10. The device of claim 1, further comprising:
a first filter coupled to an input of the first switched converter circuit; and
a second filter coupled to an output of the second switched converter circuit,
wherein the first filter and the second filter are configured to provide substantially sinusoidal signals.

11. The device of claim 1, wherein the first switched converter circuit implements 3-level conversion and the second switched converter circuit implements 3-level conversion.

12. The device of claim 1, wherein the first switched converter circuit implements 5-level conversion and the second switched converter circuit implements 5-level conversion.

13. The device of claim 1, wherein the first switched converter circuit may be configured to adjust a first number of conversion levels of signals at the device input and the second switched converter circuit may be configured to adjust a second number of conversion levels of signals at the device output.

14. The device of claim 1, wherein the first switched converter circuit includes a first plurality of configurable semiconductor switches and second switched converter circuit includes a second plurality of configurable semiconductor switches.

15. The device of claim 14, wherein a first number of configurable semiconductor switches in the first plurality of configurable semiconductor switches is selected based on a voltage level of signals at the device input and a voltage limit of the first plurality configurable semiconductor switches, and a second number of configurable semiconductor switches in the second plurality of configurable semiconductor switches is selected based on a voltage level of signals at the device output and a voltage limit of the second plurality configurable semiconductor switches.

16. The device of claim 15, wherein a first number of configurable semiconductor switches in the first plurality of configurable semiconductor switches is selected from a group consisting of 2(N₁−1), 3(N₁−1), 4(N₁−1), and 6(N₁−1), where N₁ is a number of conversion levels of the signals at the device input, and wherein a second number of configurable semiconductor switches in the second plurality of configurable semiconductor switches is selected from a group consisting of 2(N_{O}−1), 3(N_{O}−1), 4(N_{O}−1), and 6(N_{O}−1), where N_{O} is a number of conversion levels of the signals at the device output.

17. The device of claim 1, wherein the device is configurable for bidirectional power flow.

18. The device of claim 1, wherein a frequency of signals at the device output is configurable.

19. The device of claim 1, wherein the first switched converter circuit is configured to receive signals at the device input having 3-phases separated by substantially 120°.

20. The device of claim 1, wherein the second switched converter circuit is configured to output signals at the device output having 3-phases separated by substantially 120°.
